(19) United States
(12) Patent Application Publication
(10) Pub. No.: US 2008/0002889 A1
(43) Pub. Date: Jan. 3, 2008

(54) Systems and methods for extracting an approximated medial surface from a thin-wall solid

(76) Inventors: Kenji Shimada, Pittsburgh, PA (US); Tomotake Furuhata, Pittsburgh, PA (US); Soji Yamakawa, Pittsburgh, PA (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/445,915

(22) Filed: Jun. 2, 2006

(51) Int. Cl. G06K 9/48

(52) U.S. Cl. 382/197

(57) ABSTRACT

A computer-implemented method for extracting an approximated medial surface from a solid having a thin-wall geometry. The method includes generating a first mesh representative of the solid and including a plurality of mesh elements. The method further includes defining a mid-surface element for each of at least a portion of the volumetric mesh elements, segmenting a surface collectively formed by the mid-surface elements to form a plurality of surface regions, defining a boundary for each surface region, and fitting an approximate surface to each surface region and its corresponding boundary. The approximate surfaces collectively define the approximated medial surface.

### STATEMENT UNDER 37 C.F.R. § 1.84(a)(2)

The patent or application file contains at least one drawing executed in color. Copies of this patent or patent application publication with color draw-ing(s) will be provided by the Office upon request and payment of the necessary fee.

### TECHNICAL FIELD OF THE INVENTION

This application is directed generally and in various embodiments to systems and methods for extracting an approximated medial surface from a solid having a thin-wall geometry.

### BACKGROUND

Rapid improvement of computer performance has enabled the simulation of complex physical phenomena using Finite Element Method (FEM) techniques. For example, the automotive industry has integrated FEM-based crash simulation as an integral part of the design process for evaluating the crashworthiness of a vehicle. The calculated impact force history and the computer-generated animation of a crash event help engineers improve passenger safety. In simulating and rendering such physical phenomena, it is necessary to represent a geometric domain as a “mesh,” or a discretized geometry consisting of a set of simple geometric elements such as, for example, triangles and tetrahedrons.

Because mesh generation, or “meshing,” is a critical task in FEM and computer graphics, many researchers and practitioners have extensively studied the theory and applications of meshing technologies over the past four decades. The technologies have matured and are currently available in many commercial packages. It is often claimed that mesh generation problems in two dimensions, surface, and three dimensions have been satisfactorily solved. Current meshing technologies offer reasonably good solutions for basic linear FEM analysis and basic rendering tasks.

Commercially-available FEM packages, however, may not be adequate for meshing applications requiring complex, non-linear analyses. In particular, such applications often require high-quality meshes that cannot be generated automatically by current commercial mesh generators. As a result, analysis engineers must often spend considerable time and manual labor to make ideal meshes for such analyses. During the FEM analysis of injection-molded plastic parts, for example, one geometric operation typically requiring considerable manual labor is the conversion of a thin-walled solid geometry to a medial surface. Analysis engineers often prefer to model the medial surface using shell finite elements. Although some commercial meshing packages offer some capability for the automatic generation of a medial surface, none of them works robustly for complicated parts, such as those having many overlapping ribbing structures.

### SUMMARY

In one general respect, this application discloses a method for extracting an approximated medial surface from a solid having a thin-wall geometry. According to various embodiments, the method includes generating a first mesh representative of the solid and including a plurality of volumetric mesh elements. The method further includes defining a mid-surface element for each of at least a portion of the volumetric mesh elements, segmenting a surface collectively formed by the mid-surface elements to form a plurality of surface regions, defining a boundary for each surface region, and fitting an approximate surface to each surface region and its corresponding boundary. The approximate surfaces collectively define the approximated medial surface.

In another general respect, this application discloses a system for extracting an approximated medial surface from a solid having a thin-wall geometry. According to various embodiments, the system includes a volumetric mesh generator module for generating a first mesh representative of the solid and including a plurality of volumetric mesh elements. The system further includes a mid-surface element definition module for defining a mid-surface element for each of at least a portion of the volumetric mesh elements, a segmentation module for segmenting a surface collectively formed by the mid-surface elements to form a plurality of surface regions, a boundary definition module for defining a boundary for each surface region, and a surface approximation module for fitting an approximate surface to each surface region and its corresponding boundary. The approximate surfaces collectively define the approximated medial surface.

### DESCRIPTION OF THE FIGURES

FIG. 1 is a block diagram of a method for extracting an approximated medial surface from a solid having a thin-wall geometry according to various embodiments of the present invention;

FIG. 2 illustrates a perspective view of an example of a solid having a thin-wall geometry;

FIG. 3 illustrates a perspective view of a volumetric mesh representative of the solid of FIG. 2 according to various embodiments of the present invention;

FIG. 4 illustrates a perspective view of a mid-surface element defined for a corresponding volumetric mesh element according to various embodiments of the present invention;

FIG. 5 illustrates a perspective view of a surface mesh collectively formed by a plurality of mid-surface elements according to various embodiments of the present invention;

FIG. 6 illustrates a perspective view of the surface mesh of FIG. 5 subsequent to its segmentation into surface regions;

FIG. 7 illustrates a perspective view of boundaries defined for the surface regions of FIG. 6;

FIG. 8 illustrates a perspective view of a mid-surface approximation of the solid formed by fitting approximate surfaces to each surface region (FIG. 6) and its corresponding boundary (FIG. 7);

FIG. 9 illustrates a perspective view of a surface mesh representation of the mid-surface approximation of FIG. 8 according to various embodiments of the present invention; and

FIG. 10 is a diagram of a computer system for implementing the method of FIG. 1 according to various embodiments of the present invention.

### DESCRIPTION

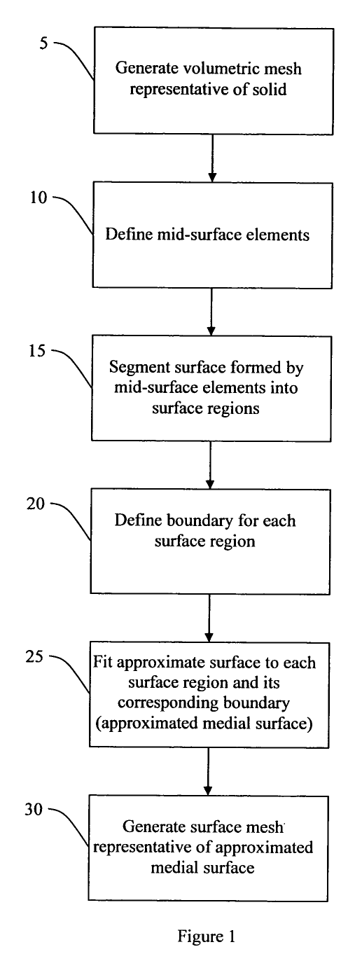

FIG. 1 is a block diagram of a method for extracting an approximated medial surface from a solid having a thin-wall geometry according to various embodiments of the present invention. The term “thin-wall solid geometry” generally refers to any solid that can be well-approximated by a shell structure. Such solids are typically characterized by small wall thicknesses and relatively large surface areas so that the ratio of area to perimeter of the cross section is small. Most sheet metal parts and injection molded plastic parts, for example, fall under the thin-wall geometry classification. The term “medial surface” refers to an abstract surface within a solid that is formed by the locus of an inscribed sphere of maximal diameter as it rolls around the interior of the solid. The medial surface provides a two-dimensional skeleton of a three-dimensional solid and is particularly useful for reducing the computational complexity of FEM analysis. Medial surface generation for solids, including those with thin-wall geometries, however, may be computationally expensive and result in extra surfaces which may not be of use to FEM analysis. As will be appreciated from the following discussion, the method of FIG. 1 enables an approximated medial surface to be extracted from a thin-wall geometry solid in a robust and computationally efficient manner, significantly reducing the time and manual effort associated with conventional medial surface generation methods.

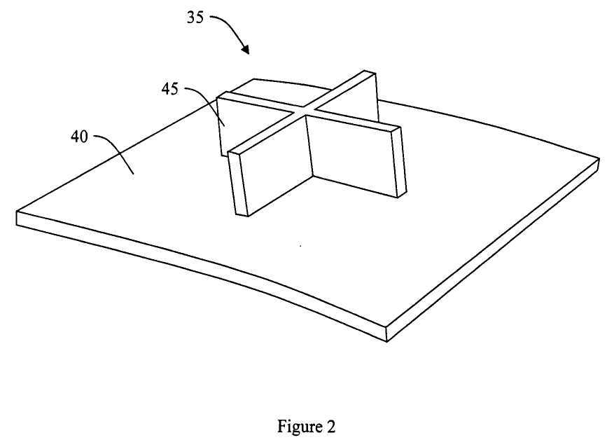

FIG. 2 illustrates an example of a solid 35 having a thin-wall solid geometry to which the method of FIG. 1 may be applied. The solid 35 may be fabricated using an injection molding process, for example, and, as shown, is characterized by a flat panel 40 having a crossing rib structure 45 formed thereon. The illustrated shape and features of the solid 35 are provided by way of example only and are not intended to limit the complexity of solids to which the method of FIG. 1 may be applied. Accordingly, it will be appreciated that the method of FIG. 1 may be applied to a variety of thin-wall solids of lesser complexity (e.g., a flat panel) or of greater complexity (e.g., an automobile dashboard component).

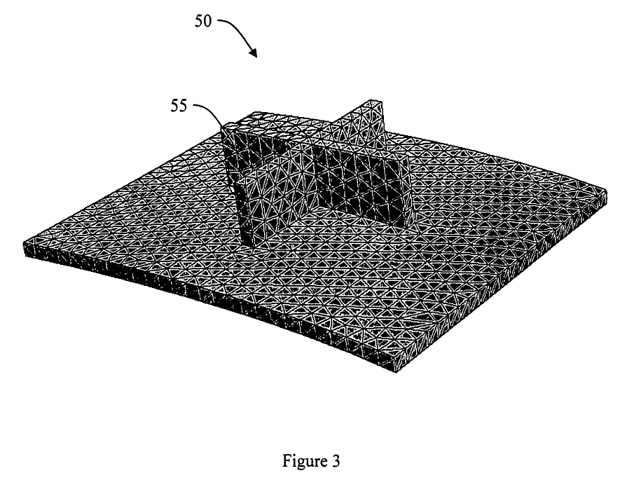

Referring again to FIG. 1, a volumetric mesh 50 (FIG. 3) representative of the solid 35 is generated at step 5. According to various embodiments and as shown in FIG. 3, the mesh 50 is generated as a single-layer mesh 50 formed from a plurality of volumetric mesh elements 55. In certain embodiments, the mesh elements 55 may be tetrahedron-shaped elements (“tets”). For such embodiments, the single-layer mesh 50 may be formed by first forming a triangular mesh on the surface of the solid 35, and then applying a known tetrahedralization technique (e.g., Delaunay tetrahedralization) to the triangular surface mesh. Creation of a single-layer mesh in this manner is described in Yamakawa et al., Layered Tetrahedral Meshing of Thin-Walled Solids for Plastic Injection Molding FEM, Symposium on Solid and Physical Modeling 2005, 245-255, which is incorporated herein by reference in its entirety.

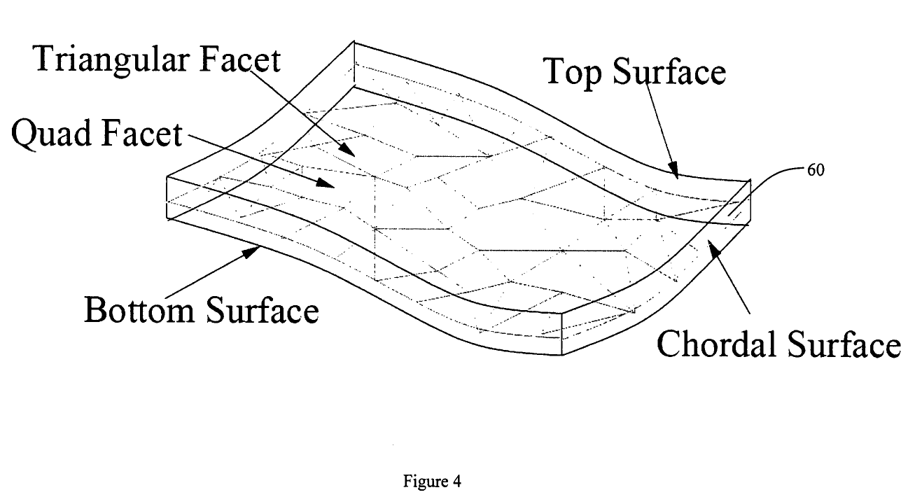

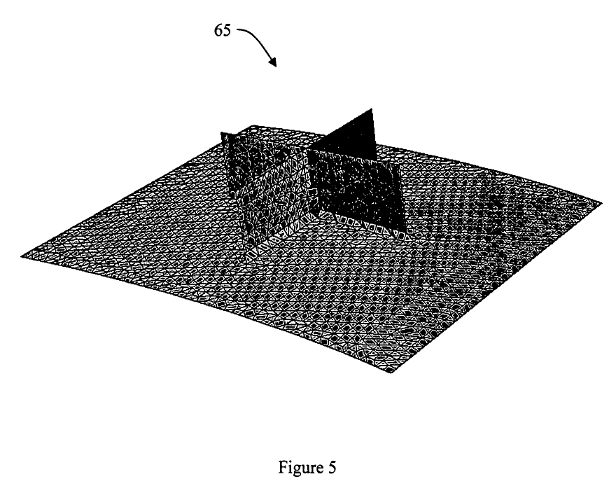

At step 10 of FIG. 1, the single-layer mesh 50 generated at step 5 is processed to define a mid-surface element 60 (FIG. 4) for each of at least a portion of the volumetric mesh elements 55. For embodiments in which the volumetric mesh elements 55 are tets, as shown in FIG. 3, each mid-surface element 60 may be defined as the chordal surface element formed by cutting the corresponding tet at its midsection. Forming mid-surface elements in this manner is described in Quadros et al., Hex-Layer: Layered All-Hex Mesh Generation on Thin Section Solids via Chordal Surface Transformation, The 11th International Meshing Roundtable, 2002, which is incorporated herein by reference in its entirety. As shown in FIG. 4, the chordal surface elements are characterized by either a triangular-shaped or a quad-shaped facet. In certain embodiments, a mid-surface element 60 is defined only for those tets connecting two surfaces (e.g., a bottom surface and a top surface) of the solid 35. Tet elements that do not satisfy this condition, such as those forming certain boundaries, joints and other intricate parts of the solid 35, may be ignored. A perspective view of a surface mesh 65 collectively formed by the plurality of mid-surface elements 60 defined at step 10 is illustrated in FIG. 5.

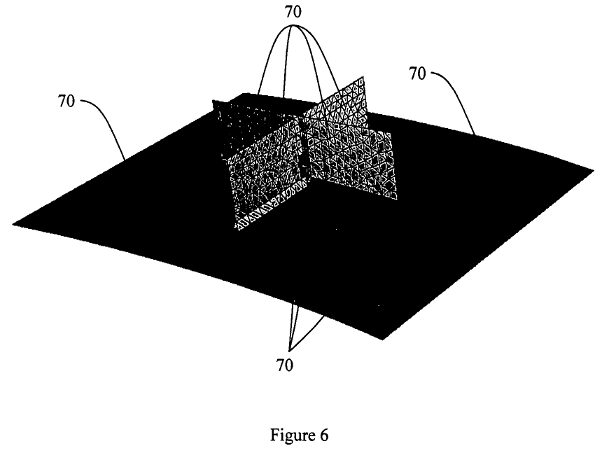

At step 15, the surface mesh 65 formed by the mid-surface elements 60 is segmented. Any suitable segmentation algorithm for segmenting the surface mesh 65 into meaningful surface regions 70 (FIG. 6) corresponding to distinct mesh surfaces may be used. In certain embodiments, for example, direct segmentation and region growing techniques such as those described in Vieira et al., Surface Mesh Segmentation and Smooth Surface Extraction Through Region Growing, Computer-Aided Geometric Design, Vol. 22, No. 8, pp. 771-92, 2005, which is incorporated herein by reference in its entirety, may be used. A perspective view of the surface mesh 65 subsequent to segmentation is illustrated in FIG. 6. Each surface region 70 is indicated by a different color and corresponds to a topologically distinct surface of the surface mesh 65.

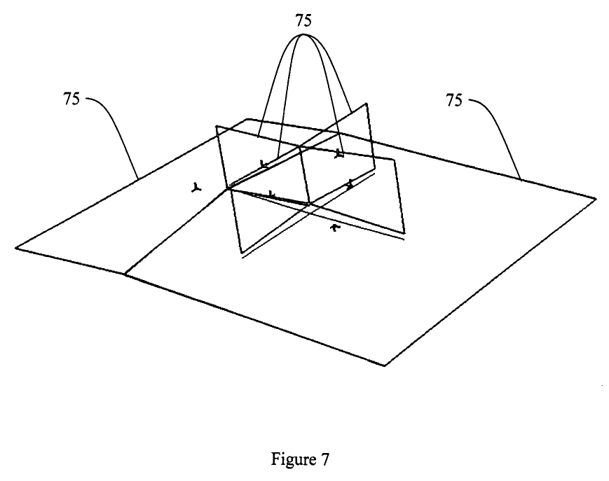

At step 20, a boundary 75 (FIG. 7) for each surface region 70 is defined. According to various embodiments, the boundary 75 of a particular surface region 70 may be defined by first identifying those mid-surface elements 60 located at the exterior edges of the surface region 70, and then forming a straight-line approximation between each set of adjacently disposed mid-surface elements 60. The straight-line approximations thus collectively form a piece-wise linear curve that defines the boundary 75 of the corresponding surface region 70. If necessary, a boundary 75 formed in this manner may be smoothed using a suitable curve-fitting algorithm. Other suitable methods for defining the boundaries 75 may alternatively be used. A perspective view of the boundaries 75 corresponding to the surface regions 70 of FIG. 6 is illustrated in FIG. 7.

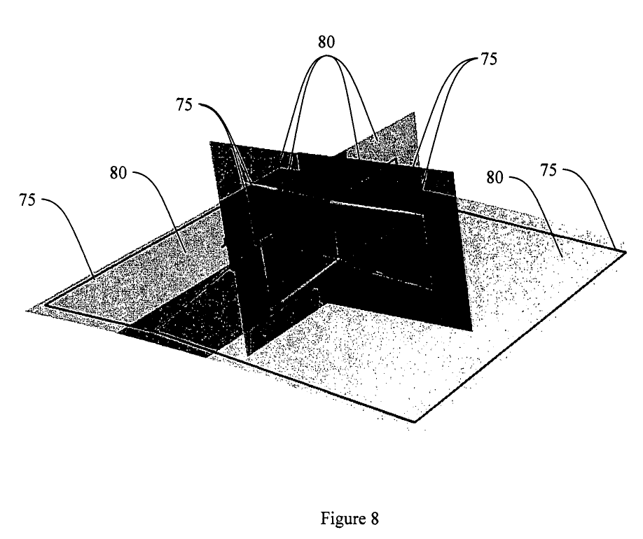

At step 25, an approximate surface 80 (FIG. 8) is fitted to each surface region 70. According to various embodiments, any suitable method for fitting an approximate surface 80 to the vertices of a surface region 70, such as, for example, base surface parameterization methods or B-spline surface fitting methods, may be used. As shown in FIG. 8, one or more of the approximate surfaces 80 may extend beyond the boundary 75 of its corresponding surface region 70, thus forming unwanted surfaces. Accordingly, the approximate surfaces 80 may be trimmed using known methods such that each conforms to its respective boundaries 75 and provides a smooth exterior edge. The approximate surfaces 80 may be joined or “stitched” using conventional surface processing techniques so as to collectively form a topologically valid mid-surface approximation of the solid 35. The joined approximate surfaces 80 collectively define the approximated medial surface of the solid 35.

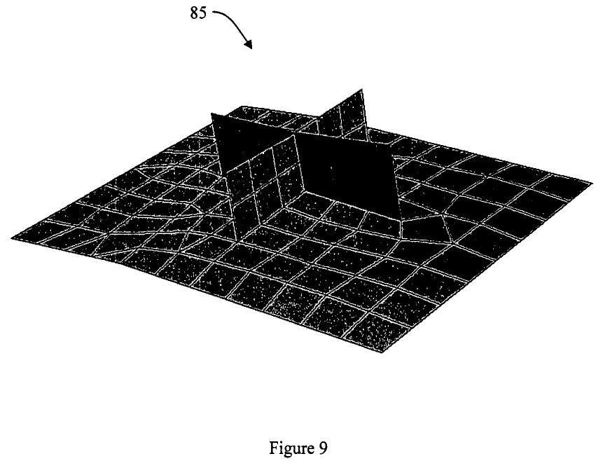

At step 30, a surface mesh 85 (FIG. 9) representative of the approximated mid-surface of step 25 is generated. According to various embodiments, the surface mesh 85 may be generated using a quadrilateral meshing technique such as described in Shimada et al., Quadrilateral Meshing with Directionality Control through the Packing of Square Cells, The 7th International Meshing Roundtable, pp. 61-75, 1998, which is incorporated herein by reference in its entirety. Other suitable meshing techniques may alternatively be used to generate the surface mesh 85.

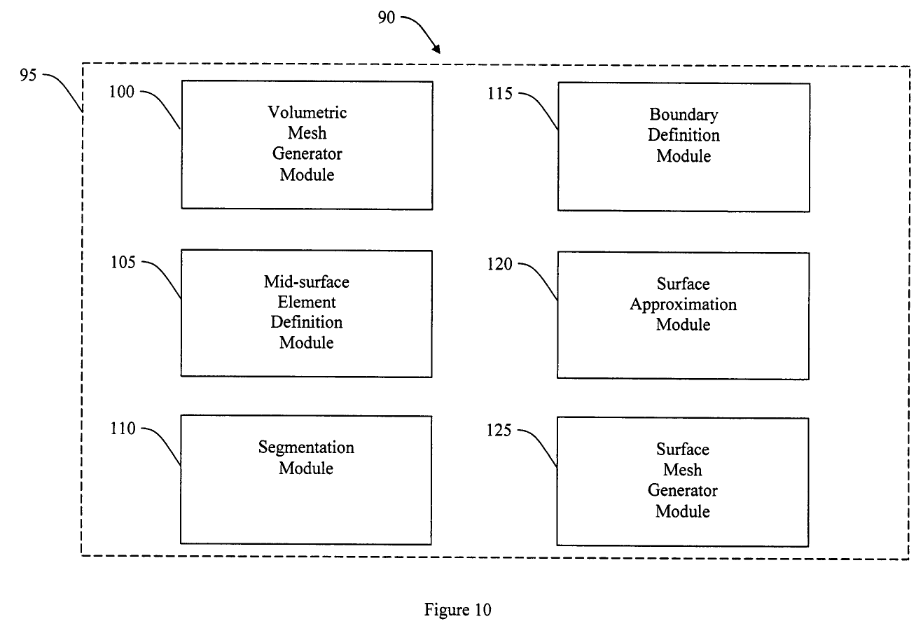

FIG. 10 is a diagram of a computer system 90 for implementing the method of FIG. 1 according to various embodiments. The computer system 90 may include a computing device 95, which may be implemented as one or more networked computers, such as personal computers, servers, etc. The computer system 90 may include a volumetric mesh generator module 100, a mid-surface element definition module 105, a segmentation module 110, a boundary definition module 115, and a surface approximation module 120. Embodiments of the system 90 may further include a surface mesh generator module 125. The modules 100-125 may be implemented as software code to be executed by a processor (not shown) of the computing device 95 using any suitable computer language such as, for example, Java, C, C++, Virtual Basic or Perl using, for example, conventional or object-oriented techniques. The software code for each module 100-125 may be stored as a series of instructions or commands on a computer-readable medium, such as a random access memory (RAM), a read-only memory (ROM), a magnetic medium such as a hard drive or a floppy disk, or an optical medium, such as a CD-ROM or DVD-ROM.

According to various embodiments, the volumetric mesh generator module 100 may receive as input a file (e.g., a CAD file) containing a three-dimensional model of the solid 35. The module 100 may then implement a suitable meshing algorithm for generating a volumetric mesh of the solid 35 using a plurality of volumetric mesh elements 55. As discussed above in connection with step 5 of FIG. 1 and as shown in FIG. 2, the generated mesh may be a single-layer tetrahedral mesh.

The mid-surface element definition module 105 may receive as input the mesh 50 generated by the volumetric mesh generator module 100 and define a mid-surface element 60 for each of at least a portion of the volumetric mesh elements 55, as described above in connection step 10 of FIG. 1 and as illustrated in FIGS. 4 and 5.

The segmentation module 110 may receive as input a surface mesh 65 formed by the mid-surface elements 60 for segmentation into a plurality of distinct surface regions 70, as described above in connection with step 15 of FIG. 1 and as illustrated in FIG. 6.

The boundary definition module 115 may receive as input the surface regions 70 created by the segmentation module 110 and define a boundary 75 for each surface region 70, as described above in connection with step 20 of FIG. 1 and as illustrated in FIG. 7.

The surface approximation module 120 may receive as input the surface regions 70 created by the segmentation module 110, as well as their corresponding boundaries 75 defined by the boundary definition module 115, and fit an approximate surface 80 to each surface region 70 and its corresponding boundary 75, as described above in connection with step 25 of FIG. 1 and as illustrated in FIG. 8. The approximate surfaces 80 collectively define the approximated medial surface of the solid 35.

The surface mesh generator module 125 may receive as input the approximated medial surface created by the surface approximation module 120 and generate a surface mesh representative of the approximated medial surface, as described above in connection with step 30 of FIG. 1 and as illustrated in FIG. 9.

Whereas particular embodiments of the invention have been described herein for the purpose of illustrating the invention and not for the purpose of limiting the same, it will be appreciated by those of ordinary skill in the art that numerous variations of the details, materials, configurations and arrangement of components may be made within the principle and scope of the invention without departing from the spirit of the invention. The preceding description, therefore, is not meant to limit the scope of the invention.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A computer-implemented method for extracting an approximated medial surface from a solid having a thin-wall geometry, the method comprising:
generating a first mesh representative of the solid, wherein the first mesh comprises a plurality of volumetric mesh elements;
defining a mid-surface element for each of at least a portion of the volumetric mesh elements;
segmenting a surface collectively formed by the mid-surface elements to form a plurality of surface regions;
defining a boundary for each surface region; and
fitting an approximate surface to each surface region and its corresponding boundary, wherein the approximate surfaces collectively define the approximated medial surface.

2. The method of claim 1, further comprising generating a second mesh representative of the approximated medial surface, wherein the second mesh comprises a plurality of surface mesh elements.

3. The method of claim 1, wherein generating a first mesh includes generating a single-layer mesh.

4. The method of claim 1, wherein generating a first mesh includes generating a tetrahedral mesh.

5. The method of claim 1, wherein defining a mid-surface element includes defining a chordal surface element.

6. A computer readable medium having stored thereon instructions which, when executed by a processor, cause the processor to:
generate a first mesh representative of a solid having a thin-wall geometry, wherein the first mesh comprises a plurality of volumetric mesh elements;
define a mid-surface element for each of at least a portion of the volumetric mesh elements;
segment a surface collectively formed by the mid-surface elements to form a plurality of surface regions;
define a boundary for each surface region; and
fit an approximate surface to each surface region and its corresponding boundary, wherein the approximate surfaces collectively define an approximated medial surface of the solid.

7. The computer readable medium of claim 6, wherein the instructions further cause the processor to generate a second mesh representative of the approximated medial surface, wherein the second mesh comprises a plurality of surface mesh elements.

8. The computer readable medium of claim 6, wherein the instructions for generating a first mesh include instructions for generating a single-layer mesh.

9. The computer readable medium of claim 6, wherein the instructions for generating a first mesh include instructions for generating a tetrahedral mesh.

10. The computer readable medium of claim 6, wherein the instructions for defining a mid-surface element include instructions for defining a chordal surface element.

11. A system for extracting an approximated medial surface from a solid having a thin-wall geometry, the system comprising:
a volumetric mesh generator module for generating a first mesh representative of the solid, wherein the first mesh comprises a plurality of volumetric mesh elements;
a mid-surface element definition module for defining a mid-surface element for each of at least a portion of the volumetric mesh elements;
a segmentation module for segmenting a surface collectively formed by the mid-surface elements to form a plurality of surface regions;
a boundary definition module for defining a boundary for each surface region; and
a surface approximation module for fitting an approximate surface to each surface region and its corresponding boundary, wherein the approximate surfaces collectively define the approximated medial surface.

12. The system of claim 11, further comprising a surface mesh generator module for generating a second mesh representative of the approximated medial surface, wherein the second mesh comprises a plurality of surface mesh elements.

13. The system of claim 11, wherein the first mesh is a single-layer mesh.

14. The system of claim 11, wherein the first mesh is a tetrahedral mesh.

15. The system of claim 11, wherein the mid-surface element is a chordal surface element.
